(19) United States
(12) Patent Application Publication
(10) Pub. No.: US 2008/0104870 A1
(43) Pub. Date: May 8, 2008

(54) Automobile flag with wind powered illumination of integral indicia

(76) Inventor: Ray M. Alden, Raleigh, NC (US)

Correspondence Address: Ray Alden, 808 Lake Brandon Trail, Raleigh, NC, 27610, US

(21) Appl. No.: 11/800,612

(22) Filed: May 7, 2007

Related U.S. Application Data
(63) Continuation-in-part of application No. 11/593,262, filed on Nov. 6, 2006.

(51) Int. Cl. G09F 19/08; G09F 13/00

(52) U.S. Cl. 40/422

(57) ABSTRACT

The invention described herein represents a significant improvement in the displaying of sports team logo or other meaningful indicia. A means for removably affixing indicia to a passenger vehicle is provided. Also removably affixed to the passenger vehicle is a wind powered generator in electrical communication with a plurality of LEDs. As the passenger vehicle moves, wind is captured to turn the generator to power the LEDs which illuminates the indicia. Thus the sports team logo or other indicia is observable at night without the need to run electrical wires or replace batteries.

### PRIOR AND RELATED APPLICATIONS

This application is a Continuation In Part of U.S. patent application Ser. No. 11/593,262 filed Nov. 6, 2006.

### BACKGROUND

1. Field of Invention

This invention relates to sports team flags, wind socks, kites or other logo or indicia displaying devices that are affixed or tethered to a passenger vehicle. Wherein wind created by the motion of the passenger vehicle actuates an electric generator which produces electric current to power illumination of the indicia or logo.

2. Description of Prior Invention

Many devices that can be displayed on a moving passenger vehicle are known in the prior art. Flags displaying the indicia, colors, and logos of sports teams for display on a passenger are well known. Electric generators are well known and widely utilized for converting wind energy into electrical current. Some products have recently appeared that provide a wind driven turbine which is affixed to the exterior of a motor vehicle and where wind is converted to electric current that powers LED lights. The related prior and related application referenced above discloses wind powered illuminated indicia affixed or tethered to a motor vehicle and wherein a generator is utilized to convert wind to electricity to illuminate the indicia. Other than the prior and related application, no known prior art combines the electric generator with the passenger vehicle flag and LEDs as is described herein.

### BRIEF SUMMARY

The invention described herein represents a significant improvement in the displaying of sports team logos and indicia to be observable at night time. In one embodiment a flag for affixing on a passenger vehicle is produced and operated when the vehicle is in motion as follows. A first sheet of indicia displays in a first field of view and a second sheet of indicia displays in a second field of view. Sandwiched between the two sheets of indicia are a plurality of LEDs that provide illumination of the first indicia and the second indicia so as to enhance the observability of the indicia when dark outside. The LEDs are powered by a wind generated electricity produced by a generator actuated by wind produced by the passenger vehicle's motion.

### Objects and Advantages

Accordingly, several objects and advantages of the present invention are apparent. It is an object of the present invention to provide an inexpensive durable means for communicating a message. It is an advantage that the flag is constructed on a pole designed to support the drag of the flag and the drag of the wind powered generator. It is an advantage that the flag is affixed or tethered to a passenger vehicle in a manner that does not pose a danger to other vehicles and ensures that the flag is not detachable from the vehicle. It is an advantage that the flag can take the form of a sign or display that can carry a message for other vehicle occupants to see. It is an object of the present invention that an illuminated indicia is made to be observable at night. It is an advantage that in the electric generator powered embodiment that the passenger compartment is free of electrical wires to the flag and that batteries are not needed to illuminate the flag. In an electrical storage embodiment, it is an advantage that wind generate electricity can be stored for use in illuminating indicia on the flag when the vehicle is not in motion.

Further objects and advantages will become apparent from the enclosed figures and specifications.

### DRAWING FIGURES

FIG. 1 illustrates an exploded view of a wind powered car flag bearing the sports team logo of NC State University.

### NUMERALS IN FIGURES

22 rotation
25 second printed substrate
26 second indicia
27 vehicle window
30 circuit substrate
31 first LED
32 second LED
33 propeller
35 generator
37 battery
41 generator hardware
45 connecting substrate
67 wind
98 first printed substrate
100 adhering substrate
303 first indicia

### DETAILED DESCRIPTION OF THE INVENTION

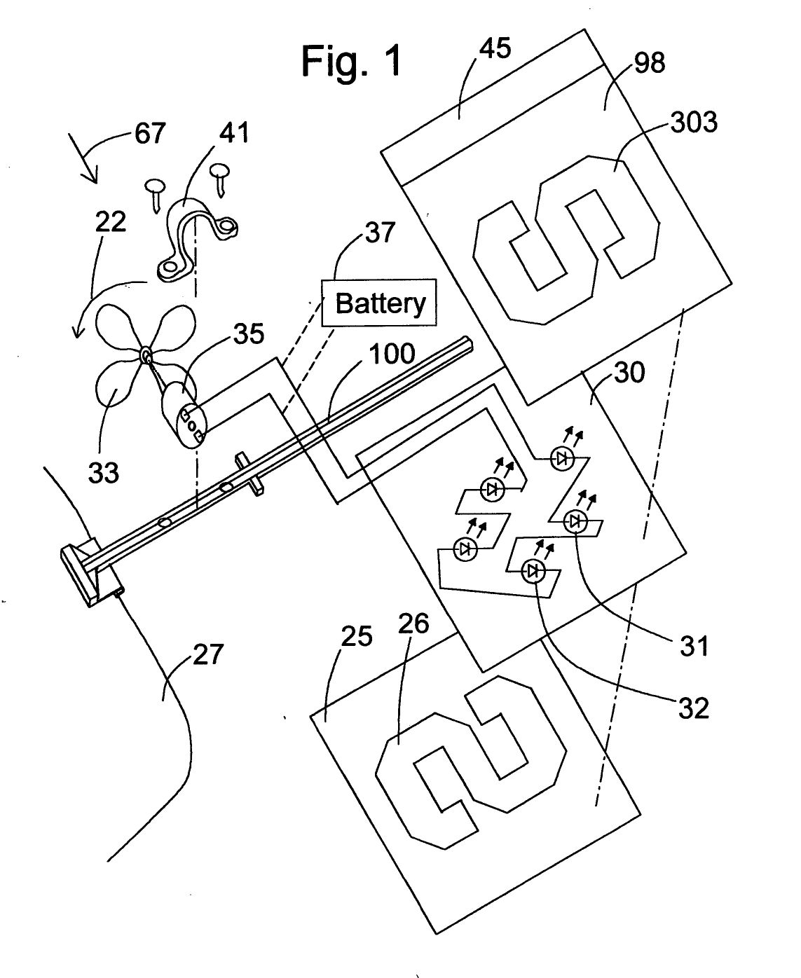

FIG. 1 illustrates an exploded view of a wind powered car flag bearing the sports team logo of NC State University. The wind powered car flag is assembled from components comprising a first printed substrate 98 which is a thin flexible translucent substrate that is colored according to colors of a sports team or other message including a first indicia 303. A second printed substrate 25 which is a thin flexible translucent substrate that is colored according to colors of a sports team or other message including a second indicia 26. The first printed substrate 98 faces in a first direction to be readable from a first side and the second printed substrate 25 faces in a second direction to be readable from a second side. As is common with flags the first and second indicia may be identical but adjoined together back to back to show the indicia properly on both sides of the flag. Sandwiched between the first printed substrate 98 and the second printed substrate 25 is a circuit substrate 30 which is a thin transparent or translucent flexible material such as fabric or plastic onto which is affixed a plurality of LEDs including a first LED 31 and a second LED 32. The LEDs are white or another suitable color to illuminate the logo and indicia of a specific message or sports team. In fact a multitude of LED colors can be used in an individual flag. The LEDs are electrically connected in series and to a generator 35. During assembly, the first printed substrate 98, the circuit substrate, and the second printed substrate 25 are sewed together to form a flag including LED illumination lights in the middle layer between the two printed substrates and affixed in a predetermined position relative to the indicia on the printed substrates. In operation, the flag can flex in the wind similar to flags commonly utilized on automobiles. A connecting substrate 45 is a fabric material which is sewed to the flag in a sleeve like configuration such that it can be slipped over an adhering substrate 100 to adhere the flag thereto. The adhering substrate is a rigid plastic flag pole that supports the flag in operation while being removably affixed to a vehicle window 27 or another part of a passenger vehicle which when the vehicle is in operation is exposed to a wind 67. As is common with automobile flags of the prior art, the flag pole is molded plastic and comprises a configuration on one end that can be closed in the automobile window as a means to secure it to the vehicle and to remove the flag from the vehicle one needs only to open the window to release the flag pole. In operation, as the motor vehicle travels the wind 67 causes a rotation 22 in a propeller 33 or turbine which is affixed to the shaft of the generator and turns elements within the generator 35 such that the generator produces electricity to power the plurality of LEDs. A battery 37 or a capacitor can be added into the circuit along with the generator and LEDs to achieve benefits such as illumination of the LEDs/indicia when the vehicle is not in motion. When a battery or capacitor is used, when the passenger vehicle is in motion, electricity from the generator recharges the battery or capacitor, thus the battery never needs to be replaced. The generator 35 can be any of a wide variety of motors, a suitable example being a Buhler Motor GmbH, #1.16.011.532, 12 volt dc which when driven by wind of greater that 50 miles/hr has suitable current output voltage and amperage to illuminate 5 LEDs from Homer TLC, Inc. product 613 980 (distributed by Home Depot). The generator 35 together with the propeller 33 are affixed to the adhering substrate 100 using a generator hardware 41 set including a clamp and screws such that the generator and propeller are not able to fly off from the adhering substrate 100 even as they are subjected to high wind speeds created by high passenger vehicle velocity. During prototyping, the propeller 33 comprised a turbine removed from a PC computer fan and then affixed to the shaft of the Buhler motor, the turbine having the right scale and properties to capture wind to drive the motor to produce suitable electrical current and voltage to power the LEDs when the passenger vehicle traveled at suitable speeds. Indicia for the purposes of this application comprises a combination of color and shape combinations that convey meaningful information including for example images, letters, numbers, logos, or other symbols.

### Operation of the Invention

Operation of the invention has been discussed under the above heading and is not repeated here to avoid redundancy.

### Conclusion, Ramifications, and Scope

Thus the reader will see that the Wind powered illuminated flag of this invention provides an inexpensive, novel, unanticipated, highly functional and reliable means for illuminating indicia on a moving passenger vehicle.

While the above description describes many specifications, these should not be construed as limitations on the scope of the invention, but rather as an exemplification of a preferred embodiment thereof Many other variations are possible for example:

As discussed in the prior related application, the generator can be affixed to the surface of the passenger vehicle instead of being affixed to the flag pole as described herein.

Other embodiments are anticipated wherein wind power generates electricity to power illumination of indicia. For example, a sign or bumper sticker comprising indicia can be affixed to the surface of the passenger vehicle and be in electrical communication with an electrical generator which is also affixed to the passenger vehicle and which captures wind to illuminate LED elements to illuminate the indicia. OLEDs are an emerging illumination technology that can be manufactured to take the form of a bumper sticker and affixed to a motor vehicle then powered by a wind powered generator as described herein to provide meaningful illuminate indicia as described herein. Also, a kite and a wind sock can comprise the components herein and be operated identically as described herein.

LEDs or OLEDs can be configured such that they themselves form the indicia which is illuminated by the wind powered generator without the need for the indicia substrate referenced herein.

Many other electrical components and configurations are possible for incorporation with the components described herein. For example a photo diode can be added such that the flag only is illuminated at dark, switches can be added to the circuit to enable a user to turn the flag off manually, a switch can be added to the circuit to enable current to be directed to the LEDs or the battery depending upon circumstances to achieve desired effects. LEDs can be wired parallel, the battery can be wired in series with the LEDs.

Airplanes, jets, helicopters, gliders, blimps, kites, and balloons, for example can all use elements described herein to be flown by vehicle passengers and used to display words and images comprising indicia.

The elements and processes described herein in connection with a passenger vehicle can also be incorporated with a wide variety f other moving vehicles such as boats or aircraft for example.

Elements described in the related prior application are incorporated herein by reference.

What is claimed:

1. A process for providing illuminated indicia on a passenger vehicle comprising he steps of;
Providing a wind powered generator,
Providing an illumination means incorporated with an indicia,
Providing an affixing means to affix the wind powered generator to the passenger vehicle,
Operating the passenger to achieve a velocity,
Wherein the velocity of said passenger vehicle exposes said wind powered generator wind causing the generator to create an electric current which causes said illumination means to illuminate said indicia.
